(19) United States
(12) Patent Application Publication
(10) Pub. No.: US 2023/0079894 A1
(43) Pub. Date: Mar. 16, 2023

(54) OPTIMISATION APPARATUS & METHOD

(71) Applicant: Ocado Innovation Limited, Hatfield (GB)

(72) Inventors: Xinan YANG, Colchester (GB); Timothy David BICKLEY, Hatfield (GB); Thomas William ADLINGTON, Hatfield (GB); Abdellah SALHI, Colchester (GB); Moncef NASRI, Hatfield (GB); Timothy COUGHLIN, Hatfield (GB); Anna MOSS, Hatfield (GB); Honsheng DAI, Colchester (GB)

(73) Assignee: Ocado Innovation Limited, Hatfield (GB)

(21) Appl. No.: 17/941,491

(22) Filed: Sep. 9, 2022

(30) Foreign Application Priority Data
Sep. 9, 2021 (GB) 2112886.3

(51) Int. Cl. G01C 21/34

(52) U.S. Cl. CPC G01C 21/343; G01C 21/3453; G01C 21/3415

(57) ABSTRACT

The present disclosure provides an apparatus, system and method for determining the route of an electric vehicle. A number of delivery destinations and a number of forecast destinations may be assigned to each of a number of groups such that a route can be determined that connects each of the nodes in each group to a central location. When a new delivery destination is received, it can be used to replace one of the forecast nodes such that the efficiency of the routes is improved, for example through a decrease in a cost function value.

### TECHNICAL FIELD

The present invention relates generally to the field of efficient utilisation of vehicles and more specifically to an apparatus and method for efficiently utilising electric vehicles when delivering customer orders.

### BACKGROUND

In recent years there has been a switch from in person shopping to online shopping. Inefficient shipping of ordered goods leads to traffic congestion, which can have negative economic and environmental consequences. For online retailers and the operators of distribution networks, there is a strong motivation to optimise their operations to reduce such environmental impacts and to enable efficient operations.

### SUMMARY

In general terms, the invention introduces an apparatus and method for determining the route of an electric vehicle, in accordance with a cost function. The cost function is determined in accordance with events and conditions that will reduce the range of an electric vehicle, such that the chance that an electric vehicle is unable to complete a route without recharging is maximised. For example, the cost function may be based one or more of the: length of the route; the number of delivery locations on the route; the predicted time to complete the route and/or the energy requirements of the route. By optimising a delivery route then the environmental impact of the delivery can be reduced, and fewer vehicles may be required to make the deliveries.

According to a first aspect of the present invention there is provided an apparatus for determining the route of an electric vehicle, the system comprising at least one processor and at least one data store, the apparatus comprising one or more processors and one or more data storage units, the apparatus being configured, in use, to: a) assign one or more delivery nodes and/or one or more forecast nodes to each of a plurality of groups; b) for each of the plurality of groups, generate a route which connects each of the nodes to a central location; c) for each of the routes, optimise the route to reduce a cost function value; d) allocate a delivery node request to one of the plurality of groups; e) for the group to which the delivery node request is allocated, determine the cost of replacing each forecast node with the delivery node request; f) replace one of the forecast nodes with the delivery node request on the basis of the replacement cost determined in step e) to generate an updated route; and g) optimise the updated route to reduce the cost function value.

The system may be configured to iterate steps d) to g) until a predetermined time threshold is reached. In an alternative, the system may be configured to iterate steps d) to g) until there are no further forecast nodes for replacement.

In step g) the optimisation of the updated route may comprise moving a node from the updated route to the route of another group. Alternatively, or in addition, the optimisation of the updated route in step g) may comprise moving a node to the updated route from the route of another group. In a further alternative, the optimisation of the updated route may comprise merging two or more routes to form a new route.

In a yet further alternative, in step g) the optimisation of the updated route may comprise generating a new route and assigning one or more nodes from the updated route to the new route. A new group may be created and the new route may be assigned to the new group. In step g) the optimisation of the updated route may comprise re-ordering the nodes within the updated route. The optimisation of the updated route may result in a shorter route.

According to a second aspect of the present invention there is provided a method of determining the route of an electric vehicle, the method comprising the steps of: i) assigning one or more delivery nodes and/or one or more forecast nodes to each of a plurality of groups; ii) generating a route, for each of the plurality of group, each route connecting each of the respective nodes to a central location; iii) optimising each of the routes to reduce a cost function value; iv) allocating a delivery node request to one of the plurality of groups; v) determining the cost of replacing each forecast node with the delivery node request for the group to which the delivery node request was allocated; vi) replacing one of the forecast nodes with the delivery node request on the basis of the replacement cost determined in step v) to generate an updated route; and vii) optimising the updated route to reduce the cost function value.

Steps iv) to vii) may be iterated until a predetermined time threshold is reached. Alternatively, steps iv) to vii) may be iterated until there are no further forecast nodes for replacement.

Optimising the updated route may comprise moving a node from the updated route to the route of another group. Alternatively, or in addition, optimising the updated route may comprise moving a node to the updated route from the route of another group.

In step vii), optimising the updated route may comprise merging two or more routes to form a new route. Alternatively, optimising the updated route may comprise generating a new route and assigning one or more nodes from the updated route to the new route. Step vii) may further comprise creating a new group and assigning the new route to the new group. In a further alternative, optimising the updated route may comprise re-ordering the nodes within the updated route. Optimising the updated route may result in a shorter route.

According to a third aspect of the present invention there is provided a data carrier device comprising computer executable code for performing a method as set out above

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a schematic diagram of a flowchart which describes the operation of a method according to the present invention;

FIG. 2 shows a schematic depiction of a region 100 which is divided into a plurality of areas;

FIG. 3 shows a schematic depiction of the region of FIG. 2 once a plurality of forecast nodes 150 are generated and then inserted into the region;

FIG. 4 shows a schematic depiction of the region of FIG. 3 when the delivery routes have been optimised so as to minimise the delivery cost function;

FIG. 5 shows a schematic depiction of the region of FIG. 3 in which a node request 200 has been received;

FIG. 6 shows a schematic depiction of the region of FIG. 5 in which the node request 200 has been accepted; and

FIG. 7 shows a schematic depiction of a computer device which may be used to implement a method according to the present invention.

### DETAILED DESCRIPTION OF EMBODIMENTS

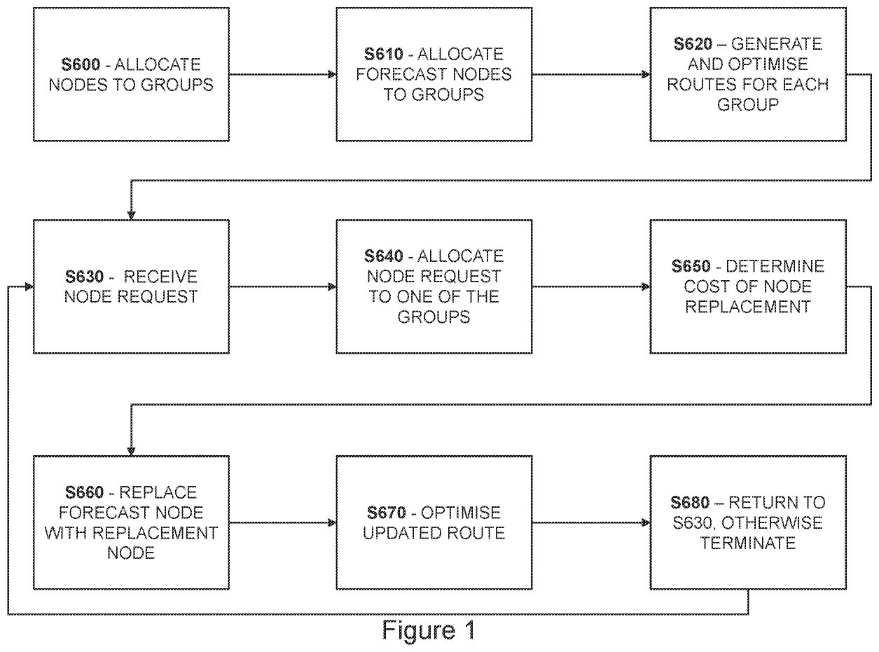

FIG. 1 is a schematic diagram of a flowchart which describes the operation of a method according to the present invention. The method begins at step S600 in which a plurality of delivery nodes are allocated between a plurality of groups, such that each of the plurality of groups comprise one or more delivery nodes. These delivery nodes correspond to locations which are associated with an order which is to be delivered. At step S610 a plurality of forecast nodes are generated and each of the forecast nodes are then assigned to one of the plurality of groups. A group may be assigned one or more of the generated forecast nodes. Each group may have a predetermined node capacity, so the number of forecast nodes assigned to a group will be limited by the node capacity for that group and the number of delivery nodes allocated to that group in S600. The node capacity of each group need not be identical. The number of nodes in a group will be limited by the vehicle which is used to make the deliveries, in respect of either weight or volume. In step S620 a route is generated for each group, each route connecting all of the nodes in the respective group in a particular order. Each of the plurality of routes is then optimised in order to minimise an objective delivery cost function.

At step S630 a node request is received. The node request comprises, in part, the location of a delivery node to be inserted into a group. The node request will be allocated into one of the groups in step S640, based in part on the location of the requested delivery node. The cost of inserting the requested delivery node into the route of the group into which the requested delivery node is allocated is determined in step 650. If the group into which the requested node is allocated comprises a plurality of forecast nodes then a replacement cost will be determined for each of those forecast nodes. The replacement cost represents the cost of replacing the respective forecast node with the requested delivery node in the route previously determined in step S620. The forecast node having the lowest replacement cost will then (step S660) be removed from the route and will be replaced by the requested node. If the group into which the requested node is allocated comprises only one forecast node then that forecast node will be replaced with the requested node at step S660. At step S670 the updated route will be re-optimised, as the insertion of the requested node into the route may mean that the delivery cost function may be further reduced, for example by re-ordering the nodes within the route or changing the path taken between consecutive nodes in the route.

At step S680 the method may be terminated. If not, the process returns to step S630 and re-iterates steps S630 to S680 until the process terminates. It can be seen that each time that he method is iterated, one forecast node is replace with a requested delivery node. The method may be terminated, for example, when a pre-determined time point is reached, when a predetermined number of requested delivery nodes have been inserted into the plurality of groups or when the number of forecast nodes remaining within the plurality of groups reaches a threshold value. Other criteria may be used when determining the termination of the method.

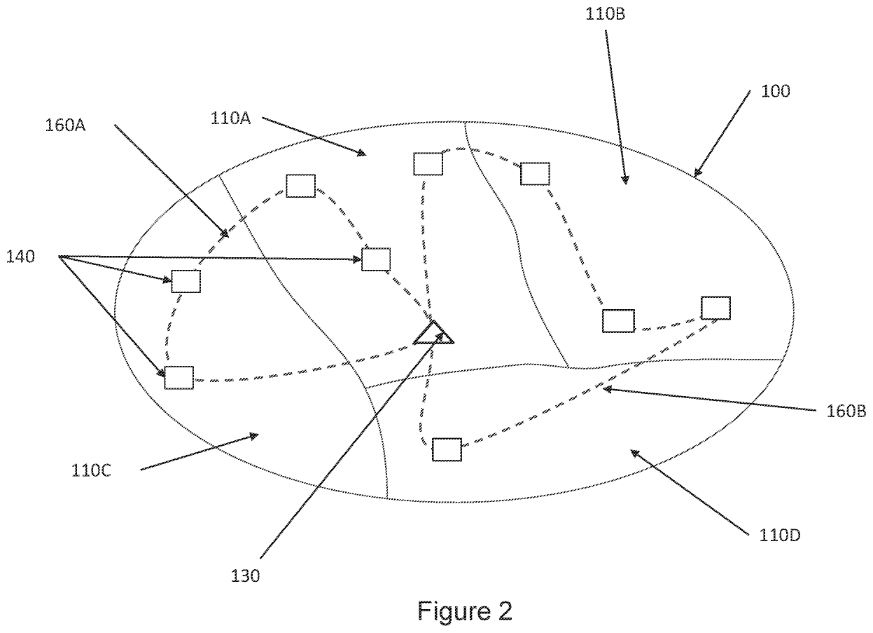

A method according to the present invention will now be described with respect to FIGS. 2 to 6. FIG. 2 shows a schematic depiction of a region 100 which is divided into a plurality of areas 110A, 1106, 110C & 110D. Located within the region 100 is a central depot 130 from which electrical vehicles (EVs) may be used to make deliveries. Also located within the region 100 are a plurality of nodes 140, each of which are locations to which deliveries are to be made. For each of the plurality of nodes, data relating to the deliveries to be made to the respective node is held, such as the volume of goods to be delivered (for example a number of bags or delivery totes of goods), the weight of goods to be delivered, the type of goods to be delivered, etc. FIG. 2 shows two delivery routes 160A and 160B, which connect the depot to all of the plurality of nodes. With reference to FIG. 1, FIG. 2 shows the result at the end of step S600, as the nodes 140 have been allocated to one of two groups and an optimised route has been determined for both groups. It should be understood that each route is constrained by the need to start and finish at the central depot, such that the EV can be loaded and charged before subsequent use.

Both of the delivery routes shown in FIG. 2 have been configured such that a delivery cost function is minimised. It should be noted that the delivery cost function is not an economic or financial cost and relates to the capacity and capability of an EV to make a delivery to a plurality of nodes. One significant limitation of an EV is the range of the vehicle. Compared with an internal combustion engine vehicle, the refuelling of an EV takes more time and recharging stations are less common, so it is important that the length of the delivery routes is less than the operating range of an EV. The operating range needs to be longer than the distance required to leave the depot, make all of the deliveries and then return to the depot. Thus, the delivery cost function may be determined in accordance with the length of the delivery route.

Additional factors that may be used when determining the delivery cost function may be the nature of the goods to be delivered. An EV which needs to maintain the temperature of chilled and/or frozen goods will have a reduced range compared to an EV which is transporting only goods which can be stored in ambient conditions. If the EV is held up by heavy traffic then there will be an energy cost in maintaining the temperature of the chilled and/or frozen goods and thus the predicted time to deliver to all of the nodes may be used as a parameter in the determination of the delivery cost function. The number of nodes in a delivery route will increase the time taken to complete the route as each node requires that the EV be stopped and then the goods for that node need to be unloaded from the EV and delivered to the customer. Thus, the number of nodes in a delivery route may be used as a parameter in the determination of the delivery cost function. It will be understood that further parameters may be used in the determination of the delivery cost function. The EV used for delivery will be limited in by weight and volume in how many orders can be carried in a single delivery, and these limitations may be used as a part of the determination of the delivery cost function. The weather conditions, such as extremes of temperature, may also effect the range of the EV and thus forecast weather conditions may be one of the factors used when determining the delivery cost function.

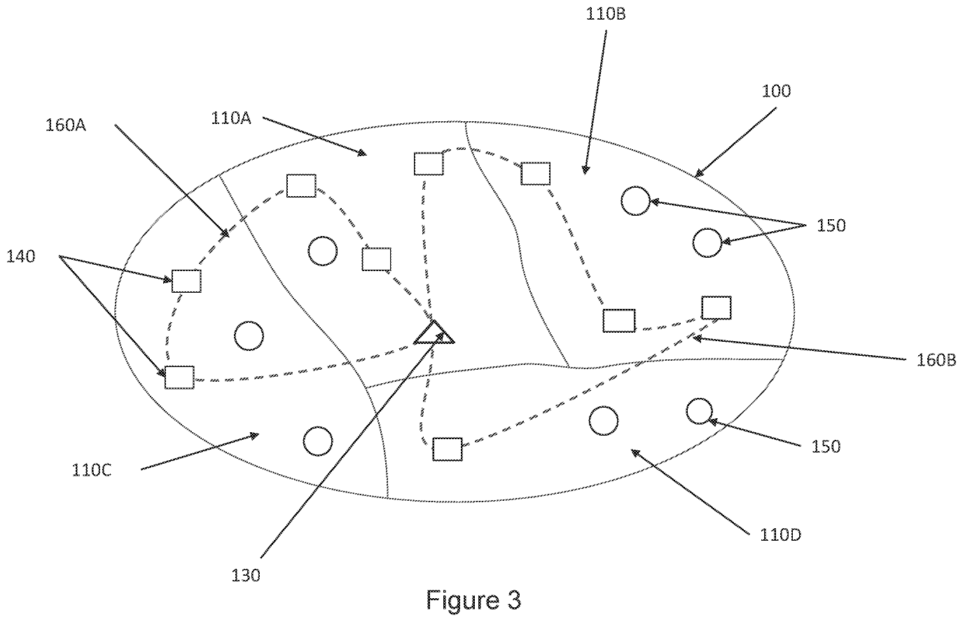

FIG. 3 shows a schematic depiction of the region of FIG. 2 once a plurality of forecast nodes 150 are generated and then inserted into the region (step S610, referring to FIG. 1). The location of the forecast nodes (and other attributes which may be associated with the forecast nodes, such as, for example, the size of an order associated with the forecast node, the type of goods which comprise that order, etc.) may be determined in accordance with historical data relating to previously received node requests.

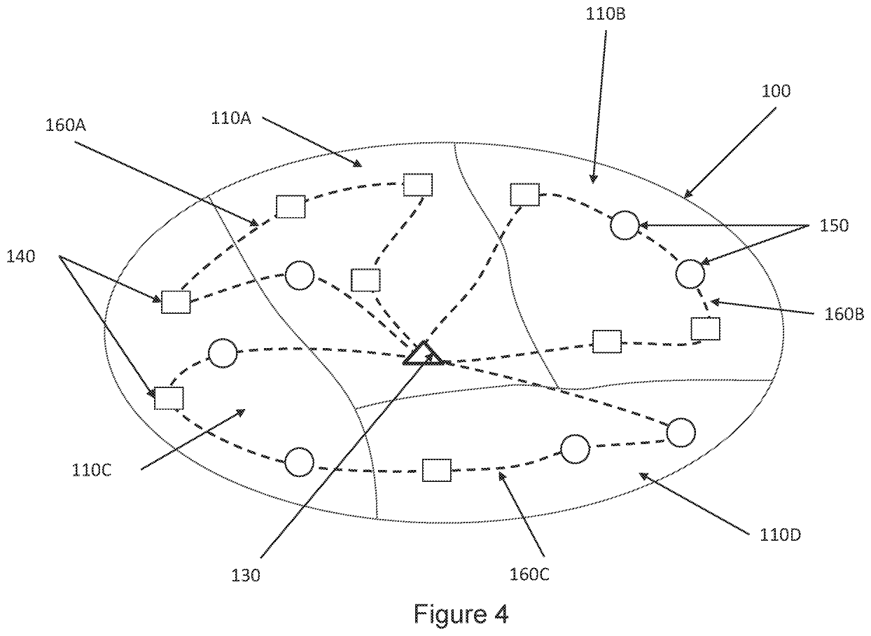

FIG. 4 shows a schematic depiction of the region of FIG. 3 when the delivery routes have been generated and optimised so as to minimise the delivery cost function (step S620 of FIG. 1). It can be seen that the optimisation has resulted in the two delivery routes shown in FIG. 2 becoming three delivery routes 160A, 160B & 160C. One limitation of a delivery vehicle is the weight and/or volume available for ordered goods. This will place a limit on the number of nodes which may be served by a single delivery route, with this limit varying with the amount of goods ordered by each node. Optimisation of a delivery route may involve the creation of a new delivery route, the merging of two or more existing delivery routes, or the deletion of an existing delivery route, or may involve a node or a forecast node being assigned from a first delivery route to a second delivery route.

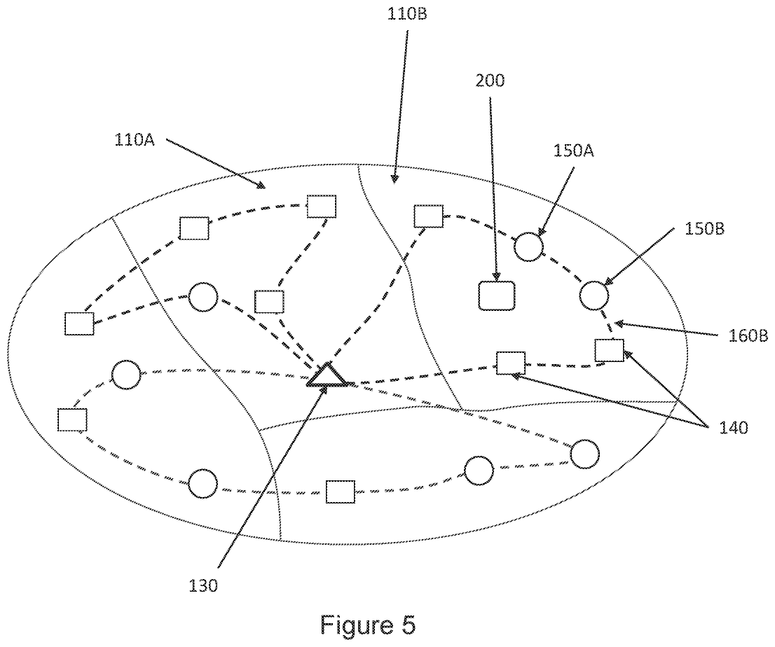

FIG. 5 shows a schematic depiction of the region of FIG. 3 in which a node request 200 has been received. The node request is located within area 1106, and specifically at a location which is bounded by the delivery route 160B. It can be seen that the node request can be satisfied by removing either a first forecast node 150A or a second forecast node 150B from the delivery route 160B and replacing it with the node request 200. The cost of replacing the first forecast node 150A with the node request 200 can be determined and the cost of replacing the second forecast node 150B with the node request 200 can also be determined. The forecast node which has the lowest replacement cost may then be deleted from the route such that the node request 200 is accepted and then becomes a node within the delivery route 160B. The delivery route may then be optimised to account for the replacement of the forecast node with the node request.

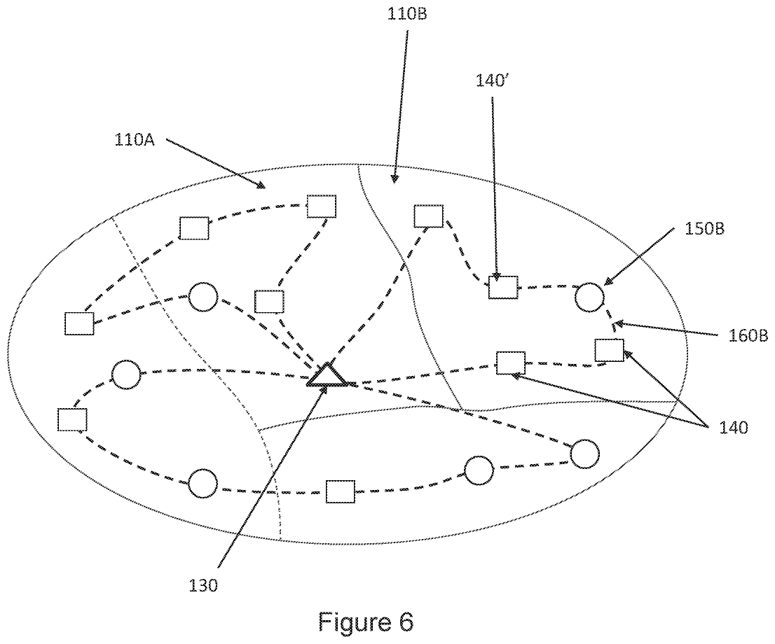

FIG. 6 shows a schematic depiction of the region of FIG. 5 in which the node request 200 has been accepted and is now shown as node 140′. Node 140′ has been accepted in place of the first forecast node 150A, which has been deleted from the delivery route 160B. The delivery route 160B has been re-optimised to account for the replacement of the first forecast node 150A with node 140′. The re-optimised delivery route 160B comprises the nodes 140 which were previously present, node 140′ and the second forecast node 150B.

As discussed above, either the first forecast node or the second forecast node is selected so that the node request may be satisfied. The selection of the forecast node is made on the basis of the value of the delivery cost function associated with inserting the forecast node into the delivery route. Table 1 below shows exemplary delivery cost function values for first and second forecast nodes for a range of different time slots.

The forecast node which has the lowest delivery cost function value may be selected to be replaced in order to satisfy the node request. For example, for the 8.00 delivery slot, the first forecast node will be selected as the delivery cost function value is 300, as compared to the delivery cost function value of 600 for the second forecast node.

TABLE 1
Exemplary delivery cost function values

| | First forecast node | Second forecast node |
|---|---|---|
| Time slot | delivery cost function value | delivery cost function value |
| 6:00 | 200 | 600 |
| 6:30 | 250 | 1200 |
| 7:00 | — | 750 |
| 7:30 | 1800 | 400 |
| 8:00 | 300 | 600 |
| 8:30 | 900 | — |
| 9:00 | 4000 | 3000 |
| 9:30 | — | — |

It can be seen that there can be significant variation in the delivery cost function values for each replacement node. A low replacement delivery cost function value indicates that the node request is near to the existing route for the assigned group (either in terms of distance or time taken). Selecting a forecast node having a low delivery cost function value makes the delivery route more environmentally efficient as it decreases the energy that is used by an EV when making the deliveries that comprise the route.

This information may be used to shape customer demand. For example, if a customer requests a delivery in the 7.00 time slot, then the delivery cost function value is 750. However, by using a different time slot it is possible for the customer to be supplied at a lower delivery cost function value (the 6.30 time slot has a value of 250 and the 7.30 time slot has a value of 400). By informing the user that these adjacent time slots have a lower environmental impact, for example by some form of visual indicator, then the user may decide to select one of these time slots.

Some timeslots may have only very high delivery cost function values. For example, the 9.00 time slot has delivery cost function values of 4000 and 3000. The system may impose a threshold value above which the replacement of a forecast node with a delivery node request does not take place. This may leave the timeslot free for a subsequent delivery request which will have a lower delivery cost function value, for example as the location of the subsequent delivery node request is closer to the delivery route in question.

Some of the entries in the table show a dash rather than a numerical value and this indicates that it is not possible for the node request to be satisfied by the respective forecast node. For example, in the 9.30 slot, neither the first or the second forecast node has a value for the delivery cost function, which may indicate that the delivery vehicle associated with that route does not have sufficient space to accept a further request.

If a node request is not associated with a particular time slot, or group of time slots, then the node request may be assigned to the time slot which has the lowest delivery cost function value. The lack of association of a node request indicates that the customer is happy to receive a delivery in any of the available time slots so the node request may be associated with the time slot that has the lowest impact on the delivery cost function.

Once the node request has been satisfied and the delivery route has been re-optimised then the method is iterated by returning to step S630. The sequence of steps S630 to S680 will be repeated until a termination condition is met. For example, the method may be iterated until there are no further node requests to be satisfied. The iteration of the method may also be terminated once all of the forecast nodes in all of the plurality of groups have been replaced with node requests. In a further alternative, the iteration of the method may be terminated at a pre-determined time threshold.

Once the method has been terminated at step S680, then the optimised delivery routes for each of the plurality of groups may be finalised and used for the delivery process. For example, if grocery orders are to be delivered then there may be a cut-off time, such as the day before the delivery date, after which no more orders are accepted. This provides times for the orders to be picked and packed. Each of the optimised delivery routes may be assigned to a delivery vehicle such that the deliveries can then be made in accordance with the route. If any of the optimised delivery routes still contain forecast nodes when the route optimisation method is terminated at step S680 then the forecast nodes may be deleted from these routes and the routes re-optimised on the basis of only the delivery nodes.

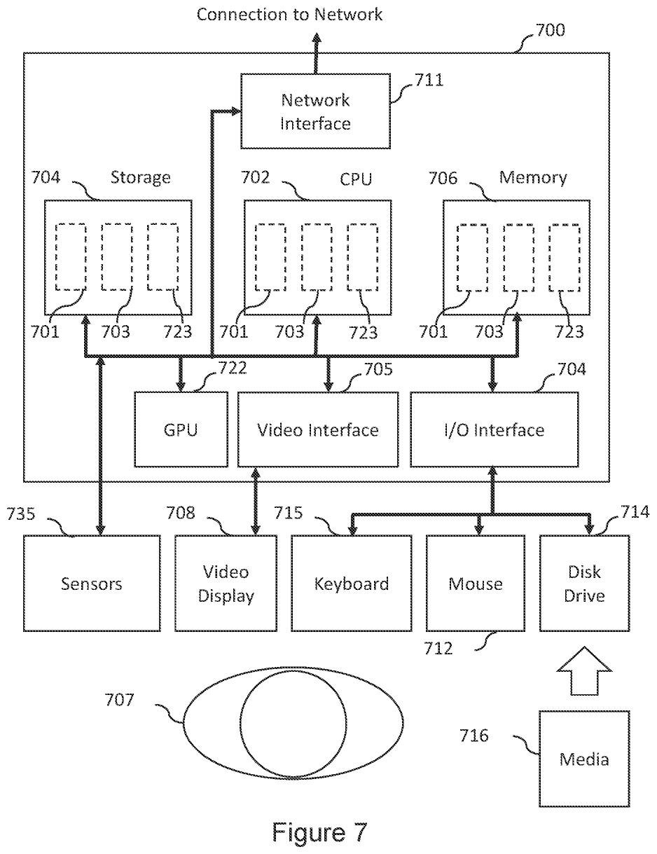

It should be understood that the determination of the different delivery routes will be made by a computer device. By way of example, FIG. 7 shows a schematic depiction of a computer device 700 that may include a central processing unit (“CPU”) 702 connected to a storage unit 714 and to a random access memory 706. The CPU 702 may process an operating system 701, application program 703, and data 723. The operating system 701, application program 703, and data 723 may be stored in storage unit 714 and loaded into memory 706, as may be required. Computer device 700 may further include a graphics processing unit (GPU) 722 which is operatively connected to CPU 702 and to memory 706 to offload intensive image processing calculations from CPU 702 and run these calculations in parallel with CPU 702.

An operator 707 may interact with the computer device 70 using a video display 708 connected by a video interface 705, and various input/output devices such as a keyboard 715, mouse 712, and disk drive or solid state drive 714 connected by an I/O interface 704. In a known manner, the mouse 712 may be configured to control movement of a cursor in the video display 708, and to operate various graphical user interface (GUI) controls appearing in the video display 708 with a mouse button. The disk drive or solid state drive 714 may be configured to accept computer readable media 716. The computer device 700 may form part of a network via a network interface 711, allowing the computer device 700 to communicate with other suitably configured data processing systems (not shown). As the present invention is implemented on software within a conventional computer device, computer code may be accessed via download, for example via the internet, or on some physical media, for example, DVD, CD-ROM, USB memory stick, etc. for which the computer device has an appropriate media reader.

Each depot 130 may comprise one or more computer devices 700 which are used to determine the delivery routes for that particular depot. Alternatively, a computing device may determine delivery routes for a plurality of depots, the depots forming part of a wider delivery network. The computer device may be formed from cloud computing platform resources, or a hybrid model of in-depot computer devices, remote computer servers or cloud computing may be used.

Modifications and Variations

Many modifications and variations can be made to the embodiments described above, without departing from the scope of the present invention. The foregoing description of embodiments of the invention has been presented for the purpose of illustration and description. It is not intended to be exhaustive or to limit the invention to the precise form disclosed.

Known techniques such as simulated annealing may be used when optimising the route, for example in step S620 or S670, or in both of these steps. Other optimisation techniques may be used as appropriate. At step S600, there may be no existing delivery nodes, for example, if the time window for booking orders has just opened. In such a case, each of the plurality of groups may comprise zero delivery nodes and then each of the plurality of groups can be filled to their respective group capacity with forecast nodes at S610. The location the forecast nodes, and the size of the order associated with each of the forecast nodes, may be determined in accordance with data derived from historical operations of the delivery system.

1. An system for determining a route of an electric vehicle, the system comprising:
one or more processors and one or more data storage units, configured to:
a) assign one or more delivery nodes and/or one or more forecast nodes to each of a plurality of groups;
b) for each of the plurality of groups, generate a route which connects each of the nodes to a central location;
c) for each of the routes, optimise the route so as to reduce a cost function value;
d) allocate a delivery node request to one of the plurality of groups;
e) for a group to which the delivery node request is allocated, determine a replacement cost for replacing each forecast node with the delivery node request;
f) replace one of the forecast nodes with the delivery node request based on the replacement cost determined in step e) to generate an updated route; and
g) optimise the updated route to reduce the cost function value.

2. A system according to claim 1, wherein the system is configured to iterate steps d) to g) until a predetermined time threshold is reached.

3. A system according to claim 1, wherein the system is configured to iterate steps d) to g) until there are no further forecast nodes for replacement.

4. A system according to claim 1, wherein in step g) the optimisation of the updated route comprises:
moving a node from the updated route to a route of another group.

5. A system according to claim 1, wherein in step g) the optimisation of the updated route comprises:
moving a node to the updated route from the route of another group.

6. A system according to claim 1, wherein in step g) the optimisation of the updated route comprises:
merging two or more routes to form a new route.

7. A system according to claim 1, wherein in step g) an optimisation of the updated route comprises:
generating a new route and assigning one or more nodes from the updated route to the new route.

8. A system according to claim 7, wherein when a new group is created, the new route is assigned to the new group.

9. A system according to claim 1, wherein in step g) the optimisation of the updated route comprises:
re-ordering the nodes within the updated route.

10. A system according to claim 1, wherein in step g) the optimisation of the updated route results in a shorter route.

11. A method of determining a route of an electric vehicle, the method comprising:
i) assigning one or more delivery nodes and/or one or more forecast nodes to each of a plurality of groups;
ii) generating a route for each of the plurality of groups, each route connecting each of the respective nodes to a central location;
iii) optimising each of the routes so as to reduce a cost function value;
iv) allocating a delivery node request to one of the plurality of groups;
v) determining a replacement cost of replacing each forecast node with the delivery node request for the group to which the delivery node request was allocated;
vi) replacing one of the forecast nodes with the delivery node request based on the replacement cost determined in step v) to generate an updated route; and
vii) optimising the updated route to reduce the cost function value.

12. A method according to claim 11, wherein steps iv) to vii) are iterated until a predetermined time threshold is reached.

13. A method according to claim 11, wherein the steps iv) to vii) are iterated until there are no further forecast nodes for replacement.

14. A method according to claim 11, wherein in step vii) optimising the updated route comprises:
moving a node from the updated route to a route of another group.

15. A system according to claim 11, wherein in step vii) optimising the updated route comprises:
moving a node to the updated route from a route of another group.

16. A system according to claim 11, wherein in step vii) optimising the updated route comprises:
merging two or more routes to form a new route.

17. A system according to claim 11, wherein in step vii) optimising the updated route comprises:
generating a new route and assigning one or more nodes from the updated route to the new route.

18. A system according to claim 17, wherein step vii) comprises:
creating a new group and assigning the new route to the new group.

19. A system according to claim 11, wherein in step vii) optimising the updated route comprises:
re-ordering the nodes within the updated route.

20. A system according to claim 11, wherein in step vii) optimising the updated route results in a shorter route.

21. A data carrier device having a non-transitory computer readable medium comprising:
computer executable code for causing a computer to perform a method according to claim 11.
